(19) United States
(12) Patent Application Publication
(10) Pub. No.: US 2002/0144535 A1
(43) Pub. Date: Oct. 10, 2002

(54) Method and apparatus for producing gas containing metal particles and for evaluating particle counter and particle trapper

(76) Inventors: Susumu Sakata, Tokyo (JP); Tetsuya Kimijima, Tokyo (JP); Yutaka Kimura, Tokyo (JP)

Correspondence Address: J.C. Patents, Inc., Suite 250, 4 Venture, Irvine, CA, 92618, US

(21) Appl. No.: 10/094,837

(22) Filed: Mar. 7, 2002

(30) Foreign Application Priority Data
Apr. 9, 2001 (JP) 2001-110566

(51) Int. Cl. G01N 27/00

(52) U.S. Cl. 73/1.03; 239/13

(57) ABSTRACT

A method and an apparatus for producing a gas containing metal particles are described, by which the metal particles can be generated quite easily in a state similar to that in real use. Also, a method and an apparatus for evaluating a particle counter or a particle trapper by using the gas containing metal particles are described, in which the evaluation is performed under the conditions similar to those in real use. The gas containing metal particles is produced by conducting a carrier gas through a hollow metal tube and simultaneously heating the hollow metal tube to produce metal particles by vaporization effect. The pressure and the flow rate of the carrier gas and the heating amount can be controlled to produce metal particles having a required size distribution and a required concentration.

### CROSS-REFERENCE TO RELATED APPLICATION

This application claims the priority benefit of Japanese application serial no. 2001-110566, filed Apr. 9, 2001.

### BACKGROUND OF THE INVENTION

1. Field of Invention

The present invention relates to a method and apparatus for producing a gas containing metal particles and for evaluating a particle counter and a particle trapper. More specifically, the present invention relates to a method and an apparatus for producing a gas that contains ultra-fine metal particles having arbitrary sizes under 1 μm and an arbitrary concentration. The present invention also relates to a method and an apparatus for evaluating various particle counters and particle trappers by using the gas containing metal particles.

2. Description of Related Art

In order to monitor and/or to control the level of ultra-fine particles in the atmosphere or in the gases used for various industrial applications, diverse particle counters and particle trappers are used currently. The particle counters include those of light-scattering type and the particle trappers include filters and scrubbers, etc. For both the manufacturer and the user, it is important to confirm and to enable that the performance of the particle counters and the particle trappers meet the requirements in real use. For example, a particle counter has to be calibrated before use for the accuracy of particle size measurement in real use. In the steps of confirming and adjusting the performance of such instruments, as standard gas containing metal particles with size and concentration being controlled is used.

In the calibration of a particle counter of light-scattering type, a polystyrene latex (PSL) with mono-disperse particles dispersed in an inert gas is usually used. Specifically, a nitrogen gas containing PSL is obtained by suspending and dispersing commercially available mono-disperse particles in ultra-pure water and then spraying and dispersing the mist containing PSL in a nitrogen gas under 1 atm. The nitrogen gas is then conducted through a dryer filled with silica gel to remove the water in the mist. Thus a nitrogen gas containing PSL is obtained.

Similarly, when the particle removing efficiency of a filter is being examined, poly-disperse particles of dioctyl phthalate (DOP), triphenyl phosphate (TPP) or the like that are dispersed in an inert gas are usually used. To prepare the fluid sample, DOP or TPP particles are suspended and dispersed in ultra-pure water and then sprayed in a nitrogen gas to be dispersed in a gas phase. Moreover, instead of the PSL dispersing liquid and the DOP dispersing liquid, the dispersing liquid of any other compound can also be atomized to produce a gas containing particles of the compound (PS or DOP). For example, ultra-fine sodium chloride particles can be dispersed in a nitrogen gas to be used in the evaluation of the removing efficiency of a particle trapper.

On the other hand, the method for producing metal particles in the prior art includes laser-vaporization, sputtering and gas aggregation. In the gas aggregation method, the heating methods include resistance heating, high-frequency heating, arc heating and plasma heating. In each method, the raw material is loaded into a crucible in a vacuum chamber filled with an inert gas and then heated to generate a metal vapor. The metal vapor will cool down immediately and condense into ultra-fine particles.

In the calibration of a particle counter of light-scattering type, it is preferable to use a calibrating gas and calibrating particles analogous to the gas and the particles being measured in real use to improve the precision of measurement. For instance, in an industrial gas used in the semiconductor industry, the water concentration has to be controlled continuously and should be reduced to the ppb level. Moreover, the particles existing in a gas come mostly from the stainless materials used in the gas supply system, which include chromium (Cr), manganese (Mn), iron (Fe) and nickel (Ni), etc. It is demanded that the levels of such particles should be well controlled.

Furthermore, in a hydrogen bromide (HBr) gas supply line, the ultra-fine particles containing manganese, which are generated during a welding process and therefore adhere inside the gas line, tend to react with HBr to generate water. This is a well-known trigger of the erosion problem in a pipeline system. Similarly, when the removing efficiency of a filter used in a HBr gas supply line is being evaluated, it is preferable to use a gas that has a water concentration controlled to be the ppb level and contains metal particles comprising stainless materials, such as Cr, Mn, Fe and Ni, etc., to simulate the situations in real use.

However, in the conventional methods for producing and supplying a gas containing ultra-fine particles, when the calibrating gas produced is used under the conditions similar to those in real use, the following problems are often encountered. Since mono-disperse particles or a water-soluble metal salt must be dispersed or dissolved in ultra-pure water and then dispersed in an inert gas by spraying, the water concentration in the calibrating gas is extremely high. Therefore, it is quite difficult to lower the water concentration to ar ultra-low level and the effect of the co-existing water must be considered. For example, when the electrostatic effect for dynamics of the ultra-fine particles is to be examined, the significant effects of the co-existing water surely have to be taken into account.

Furthermore, it is well-known in the art that several gases used in a semiconductor process may react with water to generate ultra-fine particles, so the above-mentioned wet-type method for producing a gas containing ultra-fine particles is not suitable for the evaluation of this gas. In addition, the materials of conventional standard particles, PSL, DOP and TPP, are all organic polymers or organic compounds and have properties quite different from those of the metal particles as impurities in real use. Therefore, it is highly possible that the physical properties and the dynamics of the standard particles are overly different from those of the particles being measured in real use. Moreover, for a particle counter of light-scattering type, it is well known that the counting efficiency is dependent on the material of the particles. Therefore, in order to assure the particle counting accuracy, it is necessary to use standard particles in the calibration step comprising the same material as that of the particles generated in real use.

A method that uses metal particles containing silicon compounds as the calibrating particles is also provided in the prior art, wherein the particles are generated in a dry circumstance. In this case, the so-called stainless components, such as Cr, Mn, Fe and Ni, etc., can not be used in consideration of some real adverse effects, and the conditions in calibration step are not sufficiently similar to those in real use.

Also, the conventional method for generating metal particles, such as laser vaporization, sputtering and gas aggregation (with metal vaporized in a crucible), require a vacuum system, a laser irradiator or a sputtering device. Therefore, the apparatus is bulky and quite expensive and the metal particles are difficult to generate continuously and steadily.

### SUMMARY OF THE INVENTION

Accordingly, this invention provides a method and an apparatus for producing a gas containing metal particles that are capable of easily generating metal particles in a state similar to those in real use. This invention also provides a method and an apparatus for evaluating a particle counter or a particle trapper by using the gas containing metal particles.

To achieve the object of this invention, the method for producing a gas containing metal particles comprises conducting a carrier gas based on an inert gas through a hollow metal tube and simultaneously heating the hollow metal tube from outside to generate a plurality of metal particles. At least one of the following parameters, the pressure and the flow rate of the carrier gas in the hollow metal tube and the heat input applied to the hollow metal tube from outside, etc., can be adjusted to control the size and the concentration of the metal particles. In addition, the hollow metal tube can be heated with a welding machine.

The apparatus for producing a gas containing metal particles of this invention comprises a hollow metal tube that allows a carrier gas based on an inert gas to flow through it, a heating unit for heating the hollow metal tube from outside, a gas control unit for controlling the pressure and the flow rate of the carrier gas flowing through the hollow metal tube, and a heating control unit for controlling the heat input applied by the heating unit to the hollow metal tube.

Moreover, the method for evaluating a particle counter of this invention comprises conducting a gas containing metal particles, which is produced by using the above-mentioned method of this invention, into a particle counter being evaluated and into a standard particle counter, respectively. The values obtained by the particle counter being evaluated and those obtained by the standard particle counter are then compared to evaluate the particle counter being evaluated.

In the method for evaluating a particle trapper of this invention, a gas containing metal particles, which is produced by using the above-mentioned method of this invention, is conducted into a standard particle counter to measure a first particle size distribution and a first concentration of the metal particles. The gas is also conducted through a particle trapper being evaluated and then into the standard particle counter to measure a second particle size distribution and a second concentration of the metal particles. The second particle size distribution and the second concentration are then compared with the first particle size distribution and the first concentration to evaluate the removing efficiency of the particle trapper.

Furthermore, the apparatus for evaluating a particle counter and a particle trapper of this invention comprises a gas producing unit for producing a gas containing metal particles with a required size distribution and a required concentration, a suction unit for emitting a portion of the gas containing metal particles and for sucking a remaining portion of the gas isokinetically, an evaluating line for conducting the gas sucked by the suction unit into a particle counter or a particle trapper being evaluated, a standard line for conducting the gas flowing through the particle counter or the particle trapper being evaluated into the a particle measuring unit equipped with a standard particle counter, and a bypass line branching from between the suction unit and the evaluating line for conducting the gas into the standard line bypassing the particle counter or the particle trapper being evaluated.

In the apparatus for evaluating a particle counter and a particle trapper of this invention, the particle measuring unit may include a classifier at the up-stream of the standard particle counter. The exhaust line of the apparatus is exposed to the outside atmosphere. The apparatus can further comprise a diluting unit at the downstream of the gas producing unit for mixing the gas containing metal particles with a diluting gas to adjust the concentration of the metal particles in the gas. The suction unit can include a classifier at the downstream thereof. The gas producing unit produces the gas containing metal particles by using the method for producing a gas containing metal particles of this invention and can includes the apparatus for producing a gas containing metal particles of this invention.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic diagram of an evaluating apparatus according to a preferred embodiment of this invention;

FIG. 2 illustrates a schematic diagram of an evaluating apparatus according to another preferred embodiment of this invention;

FIG. 3 plots the variations of the concentrations (number of particles/unit volume) of the particles in different sizes with the heating time in Example 1 of this invention;

FIG. 4 plots the particle size distributions with different heat input in Example 2 of this invention;

FIG. 5 plots the particle size distributions with different flow rates of the carrier gas in Example 3 of this invention;

FIG. 6 plots the particle size distributions with different pressures of carrier gas in Example 4 of this invention;

FIG. 7 plots the correlation between the concentrations (number of particles/unit volume) of the particles in different sizes and the diluting ratio in Example 5; and

FIG. 8 plots the particle size distributions in the gas passing through the bypass line and in the gas passing through the filter, respectively.

### DESCRIPTION OF THE PREFERRED EMBODIMENTS

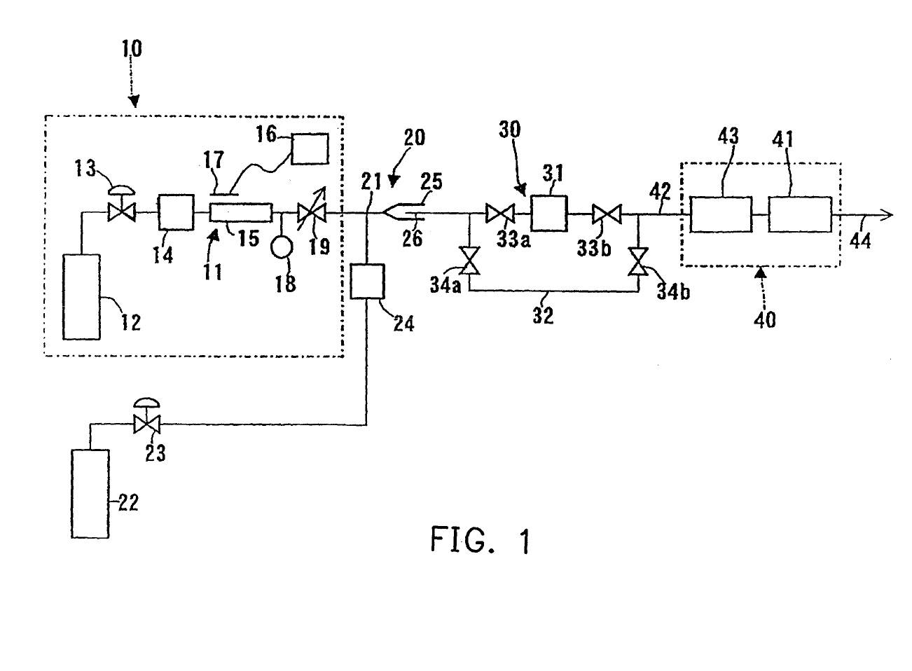

FIG. 1 illustrates a schematic diagram of an apparatus for evaluating a particle counter and a particle trapper according to a preferred embodiment of this invention, wherein the evaluating apparatus uses the apparatus for producing a gas containing metal particles of this invention as a gas producing means.

Refer to FIG. 1, the apparatus for evaluating a particle counter and a particle trapper in the preferred embodiment comprises a gas producing unit 10 having a gas-producing apparatus 11, a suction unit 20, an evaluating line 30, a standard line 42 and a bypass line 32. The gas-producing apparatus 11 is used to produce a gas containing metal particles with a required size and a required concentration. The suction unit 20 is designed to emit a portion of the gas containing metal particles and to suck a remaining portion of the gas isokinetically. The evaluating line 30 is responsible for conducting the gas sucked by the suction unit 20 into a particle counter 31 or a particle trapper 31 being evaluated (referred as the instrument 31 being evaluated hereinafter). The standard line 42 is used to conduct the gas flowing through the instrument 31 being evaluated into a particle measuring unit 40 equipped with a standard particle counter 41. The bypass line 32 branches from between the suction unit 20 and the evaluating line 30 for conducting the gas into the standard line 42 bypassing the instrument 31 being evaluated. Moreover, a diluting unit 21 may be incorporated at the downstream of the gas producing unit 10 and at the upstream of the suction unit 20 to reduce the concentration of metal particles by mixing the gas flowing from the gas producing unit 10 with a diluting gas.

The gas producing unit 10 comprises a gas supply 12, a pressure controller 13, a flow rate controller 14, a hollow metal tube 15, a welding machine 16 having a heating part 17, a pressure gauge 18 and a pressure controlling valve 19. The gas supply 12 is used to supply a carrier gas that is based on an inert gas, and the pressure controller 13 and the flow rate controller 14 are used to control the pressure and the flow rate of the carrier gas, respectively. The hollow metal tube 15 is used as a major component of the gas-producing apparatus 11 and is heated by the welding machine 16 and the heating part 17 that serve together as a heating unit. The pressure gauge 18 is used to measure the pressure of the gas flowing from the hollow metal tube 15 with metal particles therein (i.e., the gas containing metal particles). The pressure-controlling valve 19 is designed to control the pressure of the gas containing metal particles.

In the gas-producing apparatus 11, the hollow metal tube 15 comprises, for example, a stainless steel material (e.g., SUS 316L) that is frequently used in the gas supply systems applied in the semiconductor industry or in others. When the inert gas-based carrier gas supplied by the gas supply 12 is being conducted through the hollow metal tube 15, the hollow metal tube 15 is heated from outside by the heating part 17 of the welding machine 16. The inner surface of the hollow metal tube 15 thereby vaporizes to form metal particles in the carrier gas.

The carrier gas flowing through the hollow metal tube 15 can be based on an inert gas or on a mixture of inert gases that does not react with the inner surface of the hollow metal tube 15 and does not decompose, polymerize or burn even under a high temperature capable of vaporizing the material of the hollow metal tube 15. Specifically, the carrier gas preferably comprises argon (Ar), nitrogen (N₂), helium (He), neon (Ne), krypton (Kr) or xenon (Xe). Besides, the carrier gas can be carbon dioxide (CO₂) or various fluoro-compounds, such as SF₆, NF₃, HCFC-22 (CHClF₂), HCFC-123 (CHCl₂CF₃), HCFC-1124 (CHClFCF₃), HFC-125 (CHF₂CF₃), HFC-134a (CH₂FCF₃), HCFC-141b (CH₃CCl₂F), HFC-152a (CH₃CHF₂), HCFC-225ca (CF₃CF₂CHCl₂), HCFC-225cb (CClF₂CF₂CHClF), etc. In addition, the gases used for a welding process, such as an Ar—CO₂ mixture and an Ar—H₂ mixture, can also be used as the carrier gas.

The pressure inside the hollow metal tube 15 is preferably higher than that in the outside by 10 Pa˜0.5 MPa, more preferably by 100 Pa˜0.2 MPa. If the inner pressure is lower than the outer pressure, the hollow metal tube 15 will easily collapse and cannot maintain its shape when the inner surface of the hollow metal tube 15 starts to vaporize by heating. On the other hand, if the inner pressure is higher than the outer pressure by over 0.5 MPa, the hollow metal tube 15 will crack easily.

However, the absolute values of the inner pressure and the outer pressure are arbitrary if only their difference is within the above-mentioned range. For example, the absolute value of the inner pressure may range from low vacuum to 10 MPa, while the outer pressure is lower than the inner pressure by 10 Pa˜0.5 MPa.

The effects of the pressure and the flow rate of the carrier gas inside the hollow metal tube 15 and the heat input applied to the hollow metal tube 15 from outside on the generation of metal particles are described below. When the pressure of the carrier gas becomes higher, i.e., the difference between the inner pressure and the outer pressure is larger, the mode size of the metal particles is smaller and the particle concentration (number of particles/unit volume) tends to decrease. When the flow rate of the carrier gas is larger, the mode size of the metal particles is also smaller and the particle concentration (number of particles/unit volume) also tends to decrease. Moreover, when the heat input applied to the hollow metal tube 15 from outside is higher, the mode size of the metal particles is larger and the particle concentration (number of particles/unit volume) tends to increase. Therefore, the size distribution and the concentration of the metal particles can be well controlled by adjusting the pressure and the flow rate of the carrier gas and the heat input.

The type of the heater for heating the hollow metal tube 15 from outside is not specifically restricted. The heater can be a welding machine, such as a TIG welding machine capable of easily adjusting the melting amount, a laser welding machine and a plasma welding machine. The welding machine has to be capable of producing a welding fume containing metal particles in real use for the evaluation of the performance of a metal particle counter or a metal particle trapper. One of the reasons is that the welding fume, which is produced during the welding process of a pipeline, is well-known to easily cause erosion on the region adhered by it and therefore has to be monitored strictly in the supply systems of industrial gases.

The heating conditions of the hollow metal tube 15 with the welding machine 16 are the same as those adopted in the usual welding process of a pipeline system. However, unlike the welding process, this invention requires the formation of a metal fume and therefore does not have to use a filler material or the like that can connect pipelines easily. Meanwhile, the heating source (heating part 17) needs to be not moved but to be held at a fixed position to melt the hollow metal tube, so that the metal particles can be produced steadily. Moreover, the melting amount is preferably set smaller than that in ordinary welding conditions in order to maintain the shape of the hollow metal tube 15.

The diameter and the thickness of the hollow metal tube 15 are not specifically restricted if only a metal fume can be generated from its inner surface with the welding machine 16. The material of the hollow metal tube 15 is also not restricted, but is preferably the same as that of the metal particles to be measured in real use. For example, when the hollow metal tube 15 comprises a stainless material that is frequently used in gas supply systems, it is possible to generate the metal particles containing chromium (Cr), manganese (Mn), iron (Fe) and nickel (Ni), etc., for the management of a gas supply system in real use.

The diluting unit 21 is designed to reduce the particle concentration of the gas containing metal particles produced by the gas producing unit 10. A diluting gas is supplied from a diluting gas supply 22 and then conducted through a pressure controller 23 and a flow rate controller 24 to have a required pressure and a required flow rate. The diluting gas is then mixed with the gas containing metal particles to reduce the particle concentration to be a required value. The diluting gas can be the same as the carrier gas, such as an inert gas like argon (Ar) or nitrogen (N₂), and can be provided from not only the diluting gas supply 22, but also a branch from the gas supply 12 for supplying the carrier gas. Moreover, except for inert gases, CO₂, various fluoro-compounds and welding gases can be theoretically used as the diluting gas.

The suction unit 20 includes a large tube 25 allowing the gas containing metal particles to flow through it, and a suction tube 26 inserted into the large tube 25. The inside of the large tube 25 and the outside of the suction tube 26 are exposed to the outside pressure, such as the atmosphere. Therefore, a portion of the gas containing metal particles is emitted from the suction unit 20 and the other portion of the gas is sucked into the suction tube 26. By using this design, the hollow metal tube 15 can be prevented from cracking even if the suction unit 20 is affected by the outside pressure causing clogging of the gas-producing unit 10 and faulty function of the pressure controlling system. Moreover, in order to maintain the particle concentration of the gas after the suction operation, the suction tube 26 sucks the gas isokinetically.

In the evaluating line 30 and the bypass line 32, the flow path of the gas is switched by two pairs of valves (33a, 33b) and (34a, 34b), respectively. When the valves 33a and 33b are opened and the valves 34a and 34b are closed, the gas containing metal particles sucked by the suction unit 20 is conducted into a instrument 31 that is to be evaluated. When the valves 34a and 34b are opened and the valves 33a and 33b are closed, the gas containing metal particles sucked by the suction unit 20 is conducted into the standard line 42 via the bypass line 32 that bypasses the instrument 31 to be evaluated.

The particle counter 41 in the particle measuring unit 40 can be one selected from various types, including those of light-scattering type or condensation-nucleus type. When the particle counter of condensation-nucleus type is used, a front-end classifier 43 is required additionally if the size distribution data of the particles are required. However, a particle counter of light-scattering type can be used without a classifier 43 since they are generally capable of measuring the number of the particles in each size.

Moreover, when the target instrument 31 that connects with the evaluating line 30 is a particle counter only, the gas conducted out of the instrument 31 needs to be not conducted into the particle measuring unit 40. Thus the evaluating line 30 and the standard line 42 are preferably set in parallel. Furthermore, an exhaust line 44, which includes a suction pump used to conduct the gas containing metal particles into the particle measuring unit 40, is set at the downstream of the particle measuring unit 40.

When the evaluating apparatus of this invention is being used to evaluate a particle counter or a particle trapper, the instrument 31 to be evaluated is arranged between the valves 33a and 33b of the evaluating line 30 and the gas producing unit 10 is turned on to produce a gas containing metal particles. The gas is conducted into the instrument 31 and the standard particle counter 41, respectively.

In an example of this invention, an argon (Ar) gas supplied by the gas supply 12 is used as the carrier gas and is conducted into the hollow metal tube 15. The pressure and the flow rate of the carrier gas are measured by the pressure gauge 18 and adjusted by using the pressure controller 13, the pressure controlling valve 19 and the flow rate controller 14. Subsequently, the welding machine 16 is switched on to heat the hollow metal tube 15 from outside with the heating part 17, so as to produce a gas containing metal particles with a required size and a required concentration.

Moreover, when the concentration of the metal particles in the gas is required to be low, a diluting gas has to be supplied to mix with the gas containing metal particles. The diluting gas is supplied by the diluting gas supplying unit 22. The pressure and the flow rate of the diluting gas are controlled by the pressure controller 23 and the flow rate controller 24, respectively, so that the concentration of the metal particles in a gas can be controlled to be a predetermined value.

At the suction unit 20, a portion of the gas containing metal particles is emitted to the outside and the remaining gas is sucked into the suction tube 26 isokinetically. By opening/closing the valves 33a, 33b, 34a and 34b, it is possible to switch the path of the gas containing metal particles between the instrument 31 to be evaluated and the particle counter 41.

When the instrument 31 to be evaluated is a particle counter, the gas containing metal particles is conducted into the standard line 42 via the bypass line 32 and then measured for the size distribution and the concentration of the particles therein with the particle counter 41 of the particle measuring unit 40. Subsequently, the gas is conducted into the evaluating line 30 and then measured for the size distribution and the concentration of the particles therein with the particle counter 31 to be evaluated. The measuring results obtained by the two particle counters are then compared to evaluate the particle counter 31, and the particle counter 31 is thereby calibrated.

On the other hand, when the instrument 31 to be evaluated is a particle trapper, the gas containing metal particles is conducted into the standard line 42 via the bypass line 32 and then measured for the size distribution and the concentration of the particles therein with the particle counter 41 of the particle measuring unit 40. Subsequently, the gas is conducted into the particle trapper 31 through the evaluating line 30 and then into the particle counter 41 via the standard line 42, so as to be measured for the size distribution and the concentration of the particles therein. By comparing the particle size distribution and the particle concentration in the gas passing through the bypass line 32 with that of the gas passing through the particle trapper 31, the evaluation of the particle trapper 31 is done.

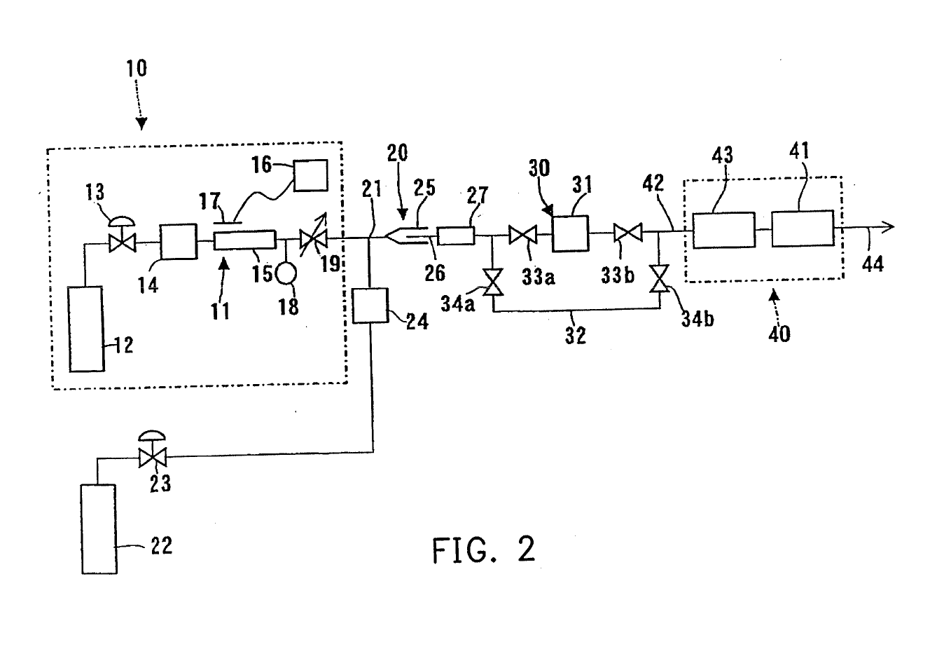

FIG. 2 shows a classifier 27 that is set at the downstream of the suction unit 20. The classifier 27 is used to create a narrow size distribution of the metal particles in the gas for the evaluation of an instrument. In FIG. 2, the same elements as those in FIG. I are labeled with the same numerals and their detailed descriptions are omitted herein.

The above-mentioned classifiers 27 and 43 each can be of any type, but a differential electrostatic classifier, such as Model 3071A manufactured by TSI Co., is preferably used. Moreover, when the classifier 27 and the particle counter 41 are arranged in series, as that illustrated in FIG. 2, the classifier 43 at the upstream of the particle counter 41 may be saved. A particle counter capable of measuring particle concentrations only, such as one of condensation nucleus type, can also be used in this case.

### EXAMPLE 1

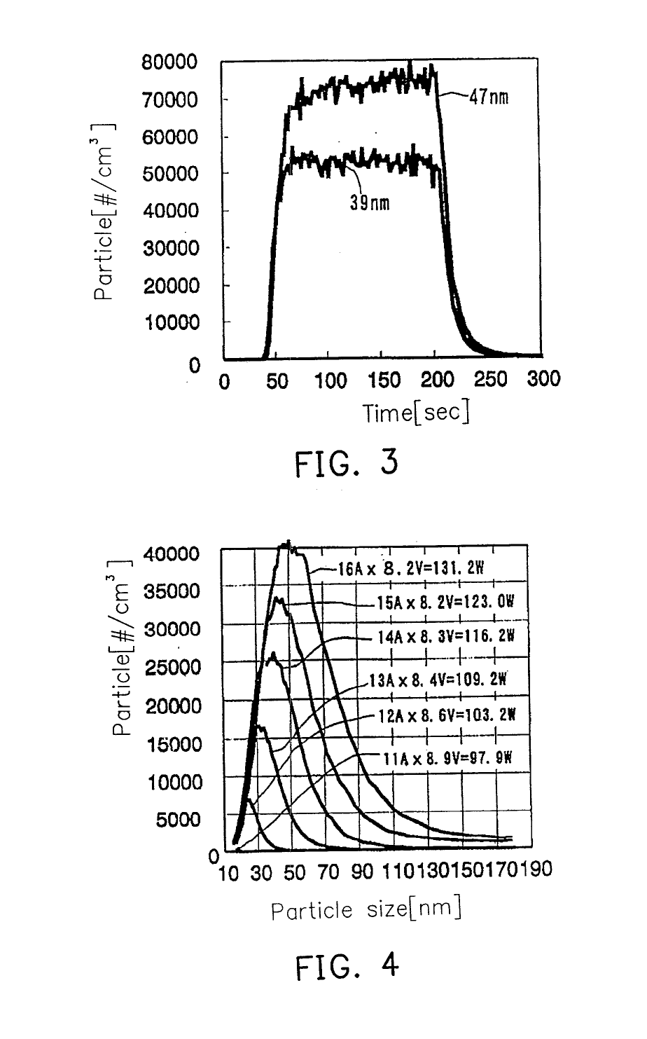

The evaluating apparatus illustrated in FIG. 1 is used in this example. In the gas producing apparatus 11 for producing a gas containing metal particles, a hollow metal tube 15 made from SUS316L with a diameter of 9.525 mm is heated for 180 seconds to produce ultra-fine metal particles. The number of the particles having a size of 39 nm or 47 nm is measured with a particle counter 41, which is one of condensation-nucleus type with classifier (model 3934 manufactured by TSI Co, Ltd.). The carrier gas used in this example comprises Ar, of which the flow rate is 3.6 L/min inside the tube and the pressure is higher than the outside pressure by 800 Pa. The heating amount (heat input) of the hollow metal tube 15 is 116.2W, which is the product of a current of 14A and a voltage of 8.3V used by the welding machine 16. As shown by the measuring results displayed in FIG. 3, the concentration of the ultra-fine particles (# of particles) become stable after heating of 60 seconds and become even more stable during the subsequent 120 seconds.

### EXAMPLE 2

The evaluating apparatus illustrated in FIG. 1 is used in this example. In the gas producing apparatus 11 for producing a gas containing metal particles, the hollow metal tube 15 also comprises SUS316L and has a diameter of ⅜ inch. The generation of the particles are measured with various heating amounts. The carrier gas used in this example comprises Ar, of which the flow rate is 3.6 L/min inside the tube and the pressure is higher than the outside pressure by 800 Pa. The measuring results are displayed in FIG. 4. As shown in FIG. 4, the nano-particles start to appear when the heating amount reaches 97.9W (11A×8.9V).

### EXAMPLE 3

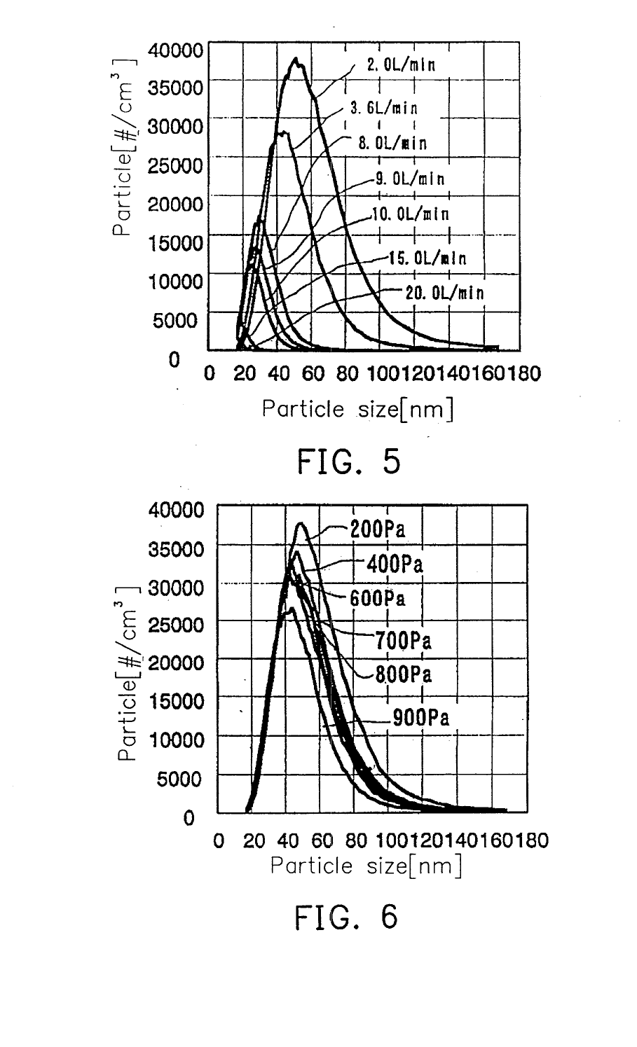

In this example, the size distributions of the metal particles are measured with various flow rates of the carrier gas in the hollow metal tube 15. The heating amount is 116.2W (14A×8.3V), the carrier gas comprises Ar and has a flow rate ranges from 2.0 to 20.0 L/mins, and the other conditions are the same as those in Example 2. As shown by the measuring results displayed in FIG. 5, the mode size and the number (concentration) of the particles are both reduced when the flow rate is increased.

### EXAMPLE 4

In this example, the size distributions of the metal particles are measured with various pressures of the carrier gas in the hollow metal tube 15. The heating amount is 116.2W (14A×8.3V), the inner pressure is higher than the outer pressure by 200˜900 Pa (pressure difference) and the other conditions are the same as those in Example 2. As shown by the measuring results displayed in FIG. 6, when the pressure difference is less than 700 Pa, the mode size and the number concentration of the particles are both reduced with increasing pressure difference. When the pressure difference exceeds 700 Pa, the mode particle size approaches 43 nm and does not decrease any more.

### EXAMPLE 5

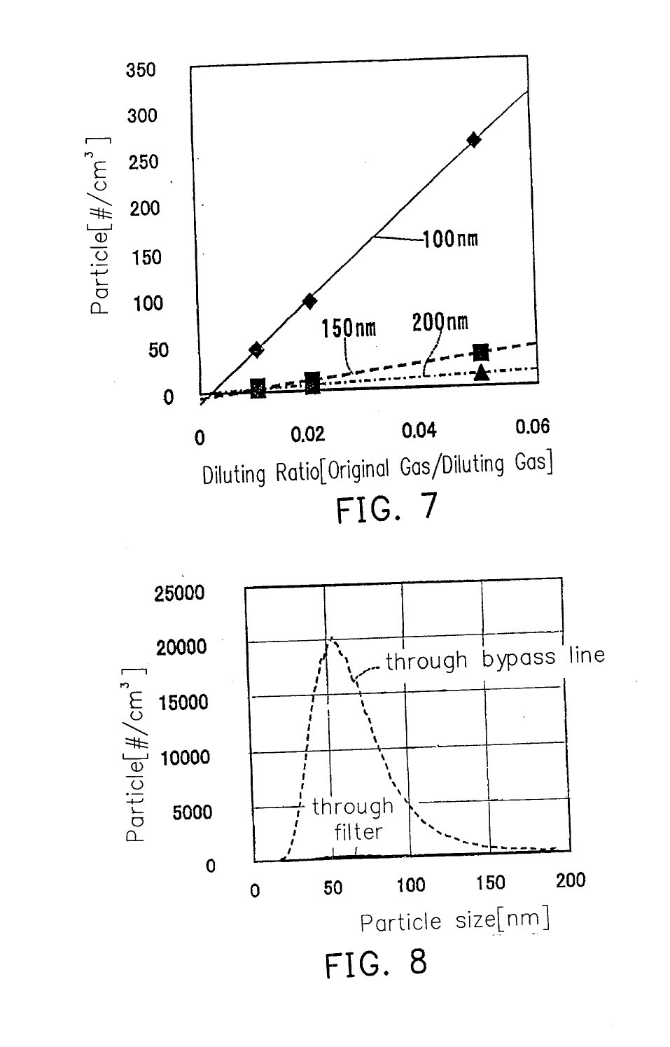

In this example, the gas containing metal particles is mixed with a diluting gas and the particle concentrations in the diluted gas are measured with various amounts of the diluting gas, while a diluting ratio is defined as the ratio of the original gas to the diluting gas. The heating amount is 116.2W (14A×8.3V) and the other conditions are the same as those in Example 2. The correlation between the particle concentration and the diluting ratio is shown in FIG. 7, which shows that the metal particles of each size can be controlled to have any concentration in the gas by selecting a corresponding diluting ratio.

### EXAMPLE 6

In this example, the instrument 31 to be evaluated is a filter, which is connected with the evaluating line 30. At first, the gas containing metal particles produced by the gas producing unit 10 is conducted through the bypass line 32 and into the particle counter 41 of the particle measuring unit 40, by which the particle concentration in the gas is measured. Subsequently, the valves 33a, 33b, 34a and 34b are opened/closed to conduct the gas through a filter and then into the particle counter 41, by which the particle concentration in the gas passing through the filter is measured. In addition, a classifier and a particle counter of condensation nucleus type are used together for the measurement and the measuring results are displayed in FIG. 8.

As shown in FIG. 8, the gas containing metal particles that passes through the bypass line 32 has mono-disperse particles and the size distribution curve has a maximum value of 20000/cm³ at the particle size of 50 nm. On the contrary, the gas passing through the filter has no particles that can be measured, which means that the removing efficiency of the filter can be confirmed to be higher than 99.99%.

In summary, by using the method and the apparatus for producing a gas containing metal particles of this invention, metal particles similar to those encountered in practical industrial gases can be generated with sizes being controlled. Moreover, the method and the apparatus for evaluating a particle counter and a particle trapper provided by this invention can make easier the calibration of a particle counter or the removing efficiency evaluation of a particle trapper.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A method for producing a gas containing metal particles, comprising
conducting a carrier gas that is based on an inert gas through a hollow metal tube; and
simultaneously heating the hollow metal tube from outside to generate a plurality of metal particles.

2. The method of claim 1, wherein a size distribution and a concentration of the metal particles are controlled by adjusting at least one parameter, including a pressure and a flow rate of the carrier gas in the hollow metal tube and a heat input of heating the hollow metal tube from outside.

3. The method of claim 1, wherein heating the hollow metal tube from outside comprises using a welding machine.

4. An apparatus for producing a gas containing metal particles, comprising:
a hollow metal tube allowing a carrier gas based on an inert gas flowing through it;
a heating unit for heating the metal tube from outside;
a gas control unit for controlling a pressure and a flow rate of the carrier gas flowing through the hollow metal tube; and
a heating control unit for controlling a heat input applied by the heating unit.

5. A method for evaluating a particle counter, comprising:
conducting a gas containing metal particles into a particle counter being evaluated and into a standard particle counter, respectively, to measure the metal particles in the gas; and
comparing a first value obtained by the particle counter being evaluated with a second value obtained by the standard particle counter to evaluate the particle counter, wherein
the gas containing metal particles is produced by conducting a carrier gas based on an inert gas through a hollow metal tube and simultaneously heating the hollow metal tube from outside to generate a plurality of metal particles.

6. A method for evaluating a particle trapper, comprising:
conducting a gas containing metal particles into a standard particle counter to measure a first particle size distribution and a first concentration of metal particles;
conducting the gas through a particle trapper being evaluated and then into the standard particle counter to measure a second particle size distribution and a second concentration of metal particles; and
comparing the second particle size distribution and the second concentration with the first particle size distribution and the first concentration to evaluate the particle trapper, wherein
the gas containing metal particles is produced by conducting a carrier gas based on an inert gas through a hollow metal tube and simultaneously heating the hollow metal tube from outside to generate a plurality of metal particles.

7. An apparatus for evaluating a particle counter and a particle trapper, comprising:
a gas producing unit for producing a gas containing metal particles with required sizes and a required concentration;
a suction unit for emitting a portion of the gas containing metal particles and for sucking a remaining portion of the gas isokinetically;
an evaluating line for conducting the gas sucked by the suction unit into a particle counter or a particle trapper being evaluated;
a standard line for conducting the gas flowing through the particle counter or the particle trapper being evaluated into the a particle measuring unit equipped with a standard particle counter; and
a bypass line branching from between the suction unit and the evaluating line for conducting the gas into the standard line bypassing the particle counter or the particle trapper being evaluated.

8. The apparatus of claim 7, wherein the standard particle counter of the particle measuring unit has a classifier at an up-stream thereof.

9. The apparatus of claim 7, wherein an exhaust line of the apparatus is exposed to an outside atmosphere.

10. The apparatus of claim 7, further comprising a diluting unit at a downstream of the gas producing unit for mixing the gas containing metal particles with a diluting gas to adjust a concentration of the metal particles.

11. The apparatus of claim 7, wherein the suction unit includes a classifier at a downstream thereof.

12. The apparatus of claim 7, wherein the gas producing unit includes a gas producing unit, the gas producing unit producing the gas containing metal particles by conducting a carrier gas based on an inert gas through a hollow metal tube in the gas producing unit and simultaneously heating the hollow metal tube from outside to generate a plurality of metal particles.

13. The apparatus of claim 7, wherein the gas producing unit includes a gas producing unit comprising:
a hollow metal tube with a carrier gas based on an inert gas flowing through it;
a heating unit for heating the metal tube from outside;
a gas control unit for controlling a pressure and a flow rate of the carrier gas flowing through the hollow metal tube; and
a heating control unit for controlling a heat input applied by the heating unit.
